(19) United States
(12) Patent Application Publication
(10) Pub. No.: US 2023/0305034 A1
(43) Pub. Date: Sep. 28, 2023

(54) SYSTEMS AND METHODS FOR FRAMING WORKSPACES OF ROBOTIC FLUID HANDLING SYSTEMS

(71) Applicant: BECKMAN COULTER., INC., Brea, CA (US)

(72) Inventors: Mark F. Sauerburger, Zionsville, IN (US); Ronald D. Johnson, Westfield, IN (US); Charles Neese, Pittsboro, IN (US)

(21) Appl. No.: 18/022,232

(22) PCT Filed: Aug. 20, 2021
(86) PCT No.: PCT/US2021/047011

§ 371 Date: Feb. 20, 2023

Related U.S. Application Data
(60) Provisional application No. 63/068,750, filed on Aug. 21, 2020.

(51) Int. Cl. G01N 35/10; G01N 35/00

(52) U.S. Cl. CPC G01N 35/1011; G01N 35/0099; G01N 2035/1013

(57) ABSTRACT

A method of framing a workspace for a working tool of a robotic fluid handler comprises positioning a liquid dispenser within a workspace of the robotic fluid handler using a transport device, moving the liquid dispenser to a general location of a component of the workspace, contacting the liquid dispenser to multiple features of the component, determining a specific location for the general location based on contacting of the liquid dispenser to the multiple features, and registering the specific location to the workspace.

### CROSS-REFERENCE TO RELATED APPLICATIONS

This application claims the benefit of and priority to U.S. Provisional Patent Application No. 63/068,750, filed Aug. 21, 2020, the entire contents of which are incorporated herein by reference.

### TECHNICAL FIELD

The present application relates generally, but not by way of limitation, to fluid handling systems, such as those that can be used in various applications to combine reagents (e.g., liquid reagents and solvents). More particularly, the present application relates to systems and methods for framing or aligning locations within a robotic fluid handling system such that a moveable working tool can be registered to locations within a workspace of the robotic fluid handling system, such as those loaded with containers of liquids for performing library constructions (e.g., libraries of DNA or RNA fragments for sequencing) using a plurality of reagents and solvents.

### BACKGROUND

To perform library construction on samples using a fluid handling system, such as a liquid handler, the fluid handling system is typically set-up by an operator or user. Set-up can include loading samples, library construction reagents, and various items of labware, such as pipette tips, plate lids, and liquid containers of various types and configurations, including reservoirs, microtiter plates, test tubes, vials, microfuge tubes, and the like. The various items of labware can have different geometries and are intended to fit within the fluid handling system in particular locations and orientations so they can be found by the working tool (e.g., a pipettor). Processing of the library construction kits can involve selecting and mixing various reagents and liquids in various labware (e.g., liquid containers) in varying quantities and volumes and at varying temperatures. As such, the working tool of the fluid handling system needs to be programmed to move to precise locations within the fluid handling system workspace in order to retrieve various samples and reagents and move such substances into various items of labware. As such, a deck of the fluid handling system can be framed, whereby the working tool is registered to various locations within the workspace of the deck.

### Overview

The present inventors have recognized, among other things, that problems to be solved in performing framing processes for fluid handling systems involve the need for specific landmarks that the working tool interfaces with to register locations to be included within the fluid handling system or on items of labware. For example, one approach to framing uses non-contact sensors, such as capacitance sensors or optical sensors, that are brought into close proximity to a landmark such that the landmark can interact with the non-contact sensor. In examples, a capacitance sensor can be mounted to a working tool and brought into proximity of a conducting landmark, or an optical sensor can be mounted to a working tool and brought into proximity of a reflective landmark. Similarly, another approach involves bringing the working tool into contact with a mechanical switch. Each of these methods requires a pre-existing landmark be installed on the fluid handling system or the labware, such as a conducting landmark, a reflective landmark or a switch. These pre-existing landmarks typically have specialized structures or features that allow them to be uniquely identified as the landmark, such as a bulls-eye engraved onto the surface of a piece of labware. Such added or exogenous structures or features are not required for the normal operation or function of the labware and are added solely to provide a distinguishable feature at a calibrated physical location for framing. As such, each of these methods requires specialized equipment, resulting in difficulty in registering equipment not provided with a landmark. For example, liquid handling systems from different manufacturers can use different framing techniques and thus require different added landmarks to the system and labware. Furthermore, the framing procedure can only be carried out at specific, pre-defined locations, e.g., the landmarks.

Additional problems associated with prior framing procedures is that the end effector, e.g., the mandrel to which various working tools are connected to be moved by a transport device, cannot be used in a free state where there are no forces acting on the end effector that might affect the position of the end effector. For example, the end effector must be brought into engagement with the mechanical switch to a level sufficient to trip the switch. Also, the end effector is typically coupled to working tools of different sizes at different times during a procedure. For example, pipette tips of multiple sizes (diameter and length) can be used in different procedures or within the same procedure and, as such, come into contact with inherent landmarks at different locations of the transport device. As such, the framing procedure must accommodate different tolerance stacking for different sized pipette tips in order to fit into various pieces of labware.

The present subject matter can provide solutions to these problems and other problems, such as by providing a fluid handling system that can perform framing procedures without requiring specifically added landmarks in the workspace or on the labware to be registered. Furthermore, the fluid handling system of the present disclosure can perform framing procedures with various instruments attached to the mandrel, such as a specialized framing tip or a pipette tip. Any location in a workspace, such as an inherent structural feature of a deck configured to hold a piece of labware, or of the piece of labware itself, can be registered as a landmark without having any uniquely identifiable structure or property added thereto. In examples, the framing instrumentation can relay a capacitance signal back to a controller for the fluid handling system. The framing instrument can have a narrow tip that can access tight locations within the fluid handling system, such as microplates. Locations of the workspace can be tightly defined such that working tools can be accurately plotted to the smallest of destinations in the workspace. Moreover, fluid handling systems of the present application can be configured to utilize generic pieces of labware, which are manufactured for universal uses, both automated and non-automated, and are thus not expected to have any added or exogenous framing landmarks for any particular fluid handling system.

In an example, a method of framing a workspace for a working tool of a robotic fluid handler can comprise positioning a liquid dispenser within a workspace of the robotic fluid handler using a transport device, moving the liquid dispenser to a general location of a component of the workspace, contacting the liquid dispenser to multiple features of the component, detecting the contacting of the liquid dispenser to the multiple features using an impedance-based sensor electrically coupled to the liquid dispenser, determining a specific location for the general location based on contacting of the liquid dispenser to the multiple features, and registering the specific location to the workspace.

In another example, a method of framing a workspace for a robotic fluid handler can comprise using a transportation device to position a framing tool within the workspace of the robotic fluid handler, moving the framing tool to an expected starting location for a feature of the workspace that is pre-programmed into a controller of the robotic fluid handler, moving the framing tool into contact with the feature, sensing contact with the feature via an impedance-based sensor of the controller that is in electrical communication with the framing tool, calculating an actual location for the feature, and storing the actual location in the controller.

In an additional example, a robotic fluid handling system can comprise a controller, a stationary deck, a component attached to the deck, a transport device controlled by the controller to move in three-dimensional space, and a liquid dispenser configured to dispense liquid into a piece of labware attached to the deck, the liquid dispenser arranged and adapted to be moved in three-dimensional space by the transport device, the liquid dispenser comprising an impedance-based sensor, wherein the controller is configured to detect contact of the liquid dispenser with a plurality of features of the component of the deck based on the amount of impedance sensed by the impedance-based sensor, wherein the controller is further configured to determine a location of the component in three-dimensional space based on the detected contact with the plurality of features.

### BRIEF DESCRIPTION OF THE DRAWINGS

FIG. 1 is a block diagram of a robotic fluid handling system according to an example of the present disclosure.

FIG. 2 is perspective view of an exemplary robotic fluid handling system of FIG. 1 comprising a housing, a carousel, a reaction vessel, a thermocycler module and an imaging device located with respect to a deck.

FIG. 3 a schematic diagram illustrating an item of labware, a labware receptacle, a transport device and an imaging device positioned relative to a deck, further illustrated in FIGS. 4 and 5.

FIG. 4 is a plan view of the deck of FIG. 3 for loading into the housing of FIG. 2 with various items of labware, including reaction vessels, a carousel and a thermocycler reservoir holder, positioned on the deck.

FIG. 5 is a plan view of the deck of FIG. 4 without the items of labware loaded thereon to show a bulk reservoir holder, a labware holder for reaction vessels, a labware holder for tip boxes or microplates and a thermocycler reservoir holder.

FIGS. 6A-6E are perspective views of a framing tool of the transport device of FIG. 3 engaging features of a wall of the bulk reservoir holder of FIG. 5 in performing a framing process.

FIG. 7 is a perspective view of the labware holder for reaction vessels of FIG. 5 and a cylindrical post located proximate the labware holder upon which a framing process can be conducted.

FIG. 8 is a perspective view of the labware holder for tip boxes or microplates of FIG. 5 upon which a framing process can be conducted.

FIGS. 9A-9B are perspective views of the thermocycler reservoir holder of FIG. 5 upon which a framing process can be conducted.

FIG. 10 is a line diagram illustrating steps of methods for framing workspaces of decks of the systems of FIGS. 1-5.

FIG. 11 is a perspective view of a manifold that can be coupled to a transport device of a fluid handling system of the present disclosure.

FIG. 12 is a cross-sectional view of the manifold of FIG. 11 taken at section 12-12 showing a circuit board, a mandrel, a pipette tip, a plunger and a connector pin.

### DETAILED DESCRIPTION

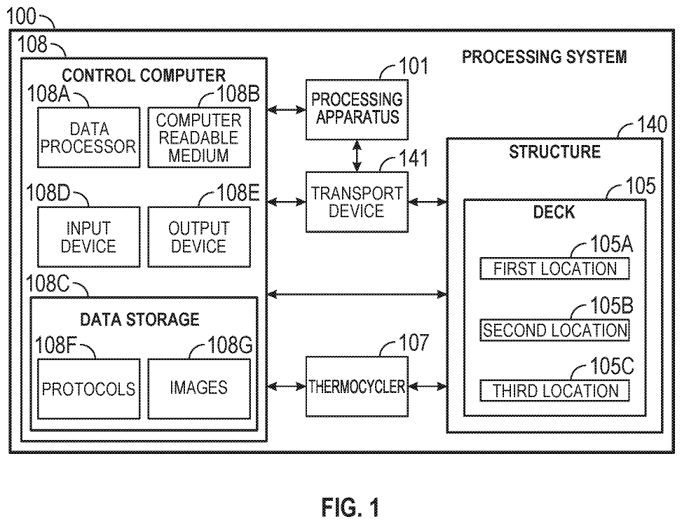

FIG. 1 is a high-level block diagram of processing system 100 according to an embodiment of the disclosure. Processing system 100 can comprise a fluid or liquid handling system with which framing processes of the present disclosure can be executed. Processing system 100 can comprise control computer 108 operatively coupled to structure 140, transport device 141, processing apparatus 101 and thermocycler system 107. Input/output interfaces can be present in each of these devices to allow for data transmission between the illustrated devices and external devices. Processing system 100 can comprise a robotic fluid handling system as described herein. Fluids can include various liquids such as reagents and the like. An exemplary processing system in which the present disclosure can be implemented is the Biomek i7 Automated Workstation marketed by Beckman Coulter, Inc. of Brea, California.

For explanatory purposes, processing system 100 will mainly be described as a system for processing and analyzing biological samples, such as the preparation of libraries of nucleic acid fragments (e.g., libraries of fragments derived from DNA or RNA molecules) including next-generation sequencing (NGS) libraries. For example, embodiments of the present disclosure can include thermocycling and incubating reagents in a reaction vessel loaded into a thermocycling system, wherein the single reaction vessel and the single thermocycling system can perform a plurality of different heating functions for different liquids loaded therein. In order to properly load reagents into the reaction vessel, it is desirable to calibrate a working tool configured to deliver the reagents to the reaction vessel.

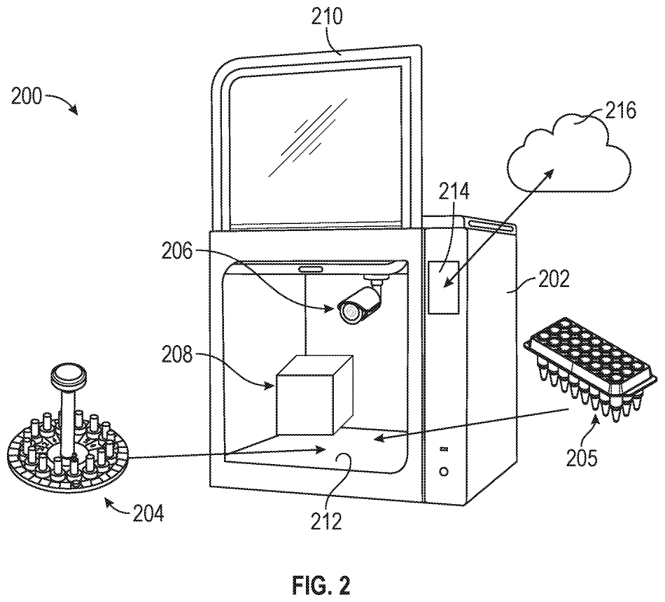

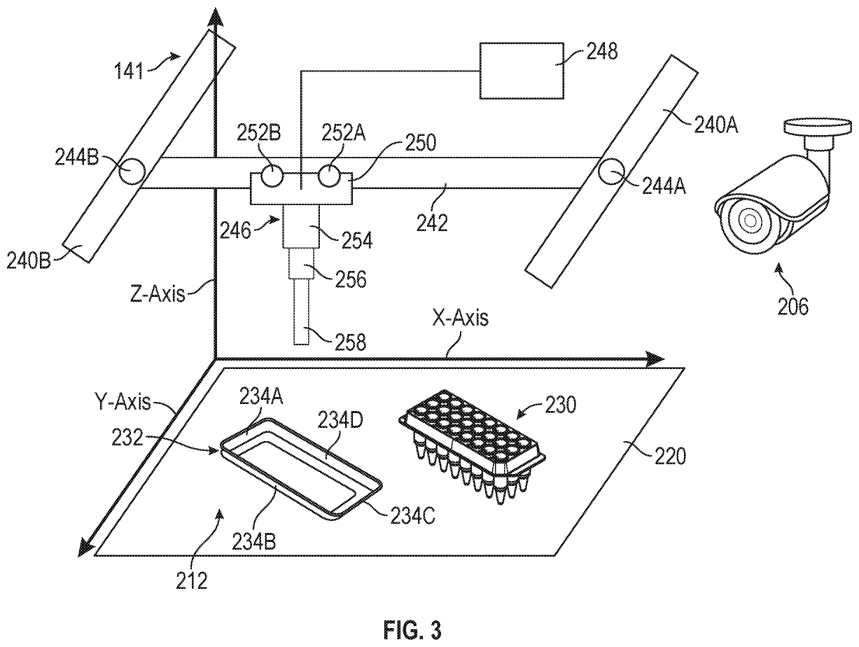

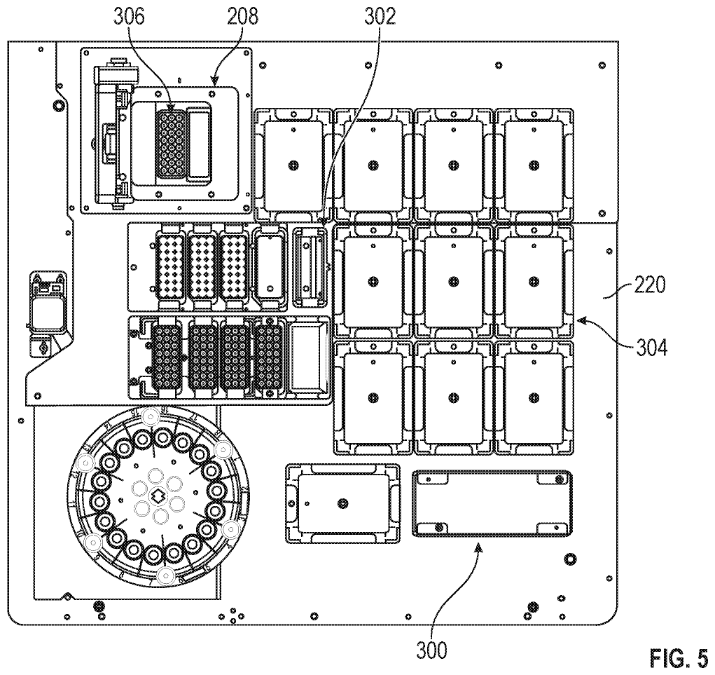

Structure 140 can include a housing (e.g., housing 202 of FIG. 2), legs or casters to support the housing, power source, deck 105 loadable within the housing, and any other suitable feature. Deck 105 can include a physical surface (e.g., platform 212 of FIG. 2) such as a planar physical surface upon which components can be reversibly placed and accessed for experiments, analyses, and processes. In some instances, deck 105 can be a floor or a tabletop surface. Deck 105 can be subdivided into a plurality of discrete deck locations (e.g., locations L1-L16 of FIG. 3) for placing different components. The locations can be directly adjacent or can be spaced apart from each other. Each deck location can include dividers, inserts, and/or any other support structure for separating the different deck locations and containing components, as shown in FIG. 5. For exemplary purposes, FIG. 1 shows first location 105A, second location 105B, and third location 105C on deck 105, though additional locations can be included. One or more of locations 105A-105C can be loaded with a carousel (e.g., carousel 204 of FIG. 2) or one or more reaction vessels (e.g. reaction vessel 205 of FIG. 2) that can include spaces for holding one or more components, such as vials of liquid. As described in greater detail below, inherent structural features of deck 105, such as the aforementioned dividers, can be used as inherent landmarks for framing processes to register locations on deck 105 to transport device 141. Additional examples of inherent structural features comprise features that are a part of the basic structure or function of the deck or labware, such as a side wall, a top surface, an opening or well, an edge, or any other facet or structure that is part of the basic structure. The inherent structural feature can provide a function unrelated to framing, such as partially holding an item of labware, or holding the processing system together, such as by coupling a deck, platform, housing or transportation system component to one or more other components. Registered locations can be stored in computer readable medium 108B for controlling movement of transport device 141 relative to deck 105.

Transport device 141 can comprise a trolley, bridge or carriage system having moving capabilities in X and Y directions and hoisting capabilities in a Z direction (see FIG. 3). Transport device 141 can represent multiple transport devices, can prepare and/or transport components between deck 105 and processing apparatus 101, as well as between different locations on deck 105. Examples of transport devices can include conveyors, cranes, sample tracks, pick and place grippers, laboratory transport elements that can move independently (e.g., pucks, hubs or pedestals), robotic arms, and other tube or component conveying mechanisms. A framing tool can be attached to or mounted onto transport device 141. In some embodiments, the framing tool can comprise a liquid aspirating and/or dispensing probe. In other embodiments, the framing tool comprises a pipetting head configured to transfer liquids. Such a pipetting head can transfer liquids within removable pipette tips and can include grippers suitable for grasping or releasing other labware, such as microwell plates.

Processing apparatus 101 can include any number of machines or instruments for executing any suitable process. For example, processing apparatus 101 can include an analyzer, which can include any suitable instrument that is capable of analyzing a sample such as a biological sample. Examples of analyzers include spectrophotometers, luminometers, mass spectrometers, immunoanalyzers, hematology analyzers, microbiology analyzers, and/or molecular biology analyzers. In some embodiments, processing apparatus 101 can include a sample staging apparatus. A sample staging apparatus can include a sample presentation unit for receiving sample tubes with biological samples, a sample storage unit for temporarily storing sample tubes or sample retention vessels, a means or device for aliquotting a sample, such as an aliquottor, a means for holding at least one reagent pack comprising the reagents needed for an analyzer, and any other suitable features. Processing apparatus 101 can further comprise a shaker or stirrer for agitating or mixing liquids and reagents, etc.

Thermocycler system 107 can be positioned relative to deck 105 and can be configured to receive a liquid vessel, such as reaction vessel 205 (FIG. 2). Liquid vessels can be loaded manually into thermocycler system 107 or via transport device 141. Thermocycler system 107 can be configured to provide a plurality of different heating zones that can heat different portions of reaction vessel 205 to different temperatures. For example, thermocycler system 107 can comprise three stacked or vertical levels of heating to provide top, middle and bottom heating zones to reaction vessel 205. Thus, for example, depending on the amount and type of liquid disposed in reaction vessel 205, different amounts of heating can be applied, such as to perform thermocycling and incubating processes.

Processing system 100 can be provided with an imaging system, e.g., a camera such as imaging device 206 (FIG. 2), to view the presence of items of labware loaded on deck 105 and to read labels of reagent vials loaded onto the items of labware. The imaging system can ensure that all portions of the workspace of deck 105 are in view of at least one camera. The imaging device can be any suitable device for capturing an image of deck 105 and any components on deck 105 or the entirety of structure 140. The imaging device can comprise one of a plurality of imaging devices mounted to or nearby structure 140 to obtain multiple views of labware and reagent vials disposed on deck 105. For example, the imaging device can be any suitable type of camera, such as a photo camera, a video camera, a three-dimensional image camera, an infrared camera, etc. Some embodiments can also include three-dimensional laser scanners, infrared light depth-sensing technology, or other tools for creating a three-dimensional surface map of objects and/or a room. In examples, the imaging device can be used to facilitate framing of deck 105, such as by providing control computer 108 an input regarding the presence of labware on deck 105.

Control computer 108 can conduct framing processes between deck 105 and transport device 141, as well as control the processes run on processing system 100, initially configure the processes, and check whether a component setup has been correctly prepared for a process. Control computer 108 can control and/or transmit messages to processing apparatus 101, transport device 141, and/or thermocycler system 107. Control computer 108 can comprise data processor 108A, non-transitory computer readable medium 108B and data storage 108C coupled to data processor 108A, one or more input devices 108D and one or more output devices 108E. Although control computer 108 is depicted as a single entity in FIG. 1, it is understood that control computer 108 can be present in a distributed system or in a cloud-based environment. Additionally, embodiments allow some or all of control computer 108, processing apparatus 101, transport device 141, and/or thermocycler system 107 to be combined as constituent parts in a single device.

Output device 108E can comprise any suitable devices that can output data. Examples of output device 108E can include display screens, video monitors, speakers, audio and visual alarms and data transmission devices. Input device 108D can include any suitable device capable of inputting data into control computer 108. Examples of input devices can include buttons, a keyboard, a mouse, touchscreens, touch pads, microphones, video cameras and sensors (e.g., light sensor, position sensors, speed sensor, proximity sensors). Additionally, input device 108D can comprise a sensor that can receive inputs from transport device 141. In examples, input device 108D can comprise an impedance-based sensor that can be in electronic communication with mandrel 254 (FIG. 3) of transport device 141. The impedance-based sensor may sense or measure electrical resistance, capacitance, inductance, or any other suitable impedance-based value, including any combination thereof. In some examples, the impedance-based sensor comprises a capacitance sensor. As such, electrical capacitance sensed at mandrel 254, or a tool loaded therein, can be relayed to the capacitance sensor located in control computer 108. In additional examples, input device 108D can comprise an encoder located at transport device 141 to provide location information to control computer 108 regarding the location of mandrel 254 and tools loaded therein relative to the workspace of deck 105.

Data processor 108A can include any suitable data computation device or combination of such devices. An exemplary data processor can comprise one or more microprocessors working together to accomplish a desired function. Data processor 108A can include a CPU that comprises at least one high-speed data processor adequate to execute program components for executing user and/or system-generated requests. The CPU can be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

Computer readable medium 108B and data storage 108C can be any suitable device or devices that can store electronic data. Examples of memories can comprise one or more memory chips, disk drives, etc. Such memories can operate using any suitable electrical, optical, and/or magnetic mode of operation.

Computer readable medium 108B can comprise code, executable by data processor 108A to perform any suitable method. For example, computer readable medium 108B can comprise code, executable by processor 108A, to cause processing system 100 to perform automated processes, including framing processes, as well as to as well as to control thermocycler system 107, structure 140, transport device 141, and/or processing apparatus 101 to execute the process steps for the one or more processes described herein, particularly those described with reference to the Examples section below that describe workspace framing methods.

Computer readable medium 108B can comprise code, executable by data processor 108A, to receive and store process steps for one or more framing procedures (e.g., a procedure for identifying specific locations in a workspace, such as on deck 105, with which to reference movements of a tool or workpiece coupled to transport device 141 of a fluid handling system). Computer readable medium 108B can include expected locations on deck 105 for receptacles of labware and for the geometries of labware that can be superimposed onto the stored geometries of the receptacles. Thus, specific locations identified on deck 105 using the framing processes disclosed herein can be compensated or calibrated for the actual locations of deck 105 and labware located thereon that can shift due to manufacturing variations, shipping alterations and set-up particularities.

Computer readable medium 108B can also include code, executable by data processor 108A, for receiving results from processing apparatus 101 (e.g., results from analyzing a biological sample) and for forwarding the results or using the results for additional analysis (e.g., diagnosing a patient).

Additionally, computer readable medium 108B can comprise code, executable by data processor 108A, for obtaining an image of deck 105, identifying information (e.g., the presence of labware) in the images of deck 105, framing pieces of labware on deck 105 by comparing stored location information in computer readable medium 108B to location information obtained from a framing process, and adjusting mapping and coordinate information of processing system 100 accordingly.

Data storage component 108C can be internal or external to control computer 108. Data storage component 108C can include one or more memories including one or more memory chips, disk drives, etc. Data storage component 108C can also include a conventional, fault tolerant, relational, scalable, secure database such as those commercially available from Oracle™ or Sybase™. In some embodiments, data storage 108C can store protocols 108F and images 108G. Data storage component 108C can additionally include instructions for data processor 108A, including protocols. Computer readable medium 108B and data storage component 108C can comprise any suitable storage device, such as non-volatile memory, magnetic memory, flash memory, volatile memory, programmable read-only memory and the like.

Protocols 108F in data storage component 108C can include information about one or more protocols. A protocol can include information about one or more processing steps to complete, components used during the process, a component location layout, loading of thermocycler system 107, heating levels of thermocycler system 107 and/or any other suitable information for completing a process. For example, a protocol can include one or more ordered steps for processing a biological sample or processing a DNA library. A protocol can also include steps for preparing a list of components before starting the process. The components can be mapped to specific locations in the reaction vessel (e.g., reaction vessel 205) or in the carousel (e.g., carousel 204) or deck (e.g., deck 105) where transport device 141 can obtain the components in order to transport them or the container they are loaded into to processing apparatus 101 or thermocycler system 107. This mapping can be encoded as instructions for operating transport device 141, such as instructions directing a pipettor to aspirate a volume of liquid from a reaction vessel in the carousel and to dispense the volume at a predetermined destination, and the mapping can also be represented by a virtual image shown to a user such that the user can place the components on deck 105, the reaction vessel and the carousel. Embodiments allow processing system 100 to be used for multiple processes (e.g., multiple different sample processes or preparation procedures). Accordingly, information about multiple protocols 108F can be stored and retrieved when needed. Components on deck 105, the reaction vessels and the carousel can be rearranged, changed, and/or replenished as necessary when changing from a first process to a second process within a protocol, or when re-starting a first process within the protocol, or changing from a first protocol to a second protocol. As discussed herein, in order to properly execute protocols, it is desirable for control computer 108 to know how to manipulate transport device 141 to move the working tool to the desired three-dimensional location within the workspace of deck 105. The framing procedures described herein can increase the precision with which transport device 141 can move working tools to interact with labware located on deck 105 and in thermocycler system 107.

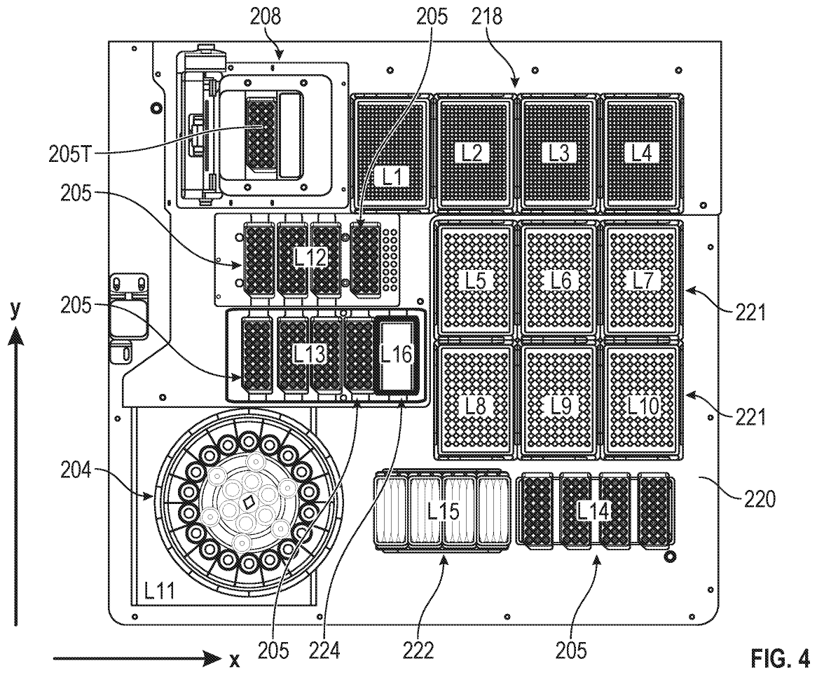

Images 108G in data storage 108C can include a real-world visual representation of deck 105, the reaction vessels and the carousel, as well as of components disposed on or in deck 105, the reaction vessels and the carousel and labels disposed on those components. In each image, deck 105, the reaction vessels and the carousel can be shown in a ready state for beginning a certain process, with components for executing a protocol placed in locations accessible to transport device 141. Each of images 108G can be associated with a specific protocol from the stored protocols 108F. In some embodiments, there can be a single image for certain protocol. In other embodiments, there can be multiple images (e.g., from different angles, with different lighting levels, or containing acceptable labware substitutions in some locations) for a certain protocol. Images 108G can be stored as various types or formats of image files including JPEG, TIFF, GIF, BMP, PNG, and/or RAW image files, as well as AVI, WMV, MOV, MP4, and/or FL V video files. As such, images 108G can provide information to control computer 108 regarding the presence of labware on deck 105 and proper positioning of such components. Deck 105 can be subdivided into a plurality of discrete deck locations for staging different components. The discrete locations can be of any suitable size. An example of deck 105 with a plurality of locations is shown loaded with labware in FIG. 4 and unloaded in FIG. 5. Deck 220 in FIG. 4 shows separate areas numbered L1 through L16, as well as thermocycler 208, which can operate as a separate location for separate types of components or packages of components. Deck 105 can have additional locations or fewer locations as desired. While these locations can be numbered or named, they can or cannot be physically labeled or marked on deck 105 in physical embodiments of the system.

As discussed herein, processing system 100 can execute framing procedures for deck 105 to ensure that the physical locations of the structures comprising areas L1-L16 match up to the expected location of areas L1-L16, stored in computer readable medium 108B, relative to transport device 141 and mandrel 254 (FIG. 3). As mentioned, the actual locations of L1-L16 can vary from machine to machine based on multiple factors, such as manufacturing tolerances, disturbances of deck 105 and the components attached thereto during shipping, and variations in final assembly and set-up of processing system 100 at a facility of an end user. Thus, even though expected locations of areas L1-L16 and the associated geometries of labware configured to sit within areas L1-L16 can be stored in computer readable medium 108B, the actual locations may vary slightly after system 100 leaves the manufacturing facility and is set-up for use at an end-user facility. As such, the framing procedures described herein can be conducted at the location of the end-user, for example, to adjust or compensate the expected locations stored in computer readable medium 108B.

FIG. 2 is perspective view of fluid handling system 200 that can comprise an example of processing system 100 of FIG. 2. Fluid handling system 200 can comprise housing 202, carousel 204, reaction vessel 205, imaging device 206 and thermocycler system 208. Note, components of FIG. 2 are not necessarily drawn to scale for illustrative purposes. Housing 202 can comprise a plurality of walls or panels that form an enclosure into which carousel 204 and reaction vessel 205 can be positioned. The enclosure can have an opening over which cover panel 210 can be positioned to encapsulate carousel 204, imaging device 206 and thermocycler system 208 within the enclosure. Housing 202 can additionally include platform 212 on which a deck, such as deck 105 (FIG. 1) or deck 220 (FIG. 3) can be positioned. The deck can include various sockets, slots or receptacles (e.g., receptacles 300, 302, 304 and 306 of FIG. 5) for receiving carousel 204, one or more of reaction vessel 205 and the like. In examples, the sockets, slots or receptacles can be configured to hold carousel 204, reaction vessel 205 and the like in predetermined or known positions relative to transport device 141 (FIG. 1, FIG. 3) and imaging device 206. Platform 212 can hold the deck in a predetermined or known position relative to housing 202 and contents therein. Housing 202 can additionally comprise space for holding controller 214, such as those of control computer 108 (FIG. 1). Controller 214 can be configured to communicate with network 216, such as via a wireless or wired communication link.

Imaging device 206 can be located within housing 202 in a stationary location. One or more imaging devices 206 can be configured to point at a single location or multiple locations in housing 202. Simultaneously, framing tip 258 (FIG. 3) of transport device 141 and processing apparatus 101 (FIG. 1) can be located within housing 202 to access location on platform 212. Transport device 141 can additionally be configured to move reaction vessel 205 into thermocycler system 208, as well as other items of labware to any of locations L1-L16 (FIG. 4). Carousel 204 can spin or rotate to present different locations to the pipettor and imaging device 206. In other examples, a single imaging device 206 can be mounted within housing 202 to move a viewing area over different portions of the interior of housing 202.

Controller 214 can be configured to execute framing procedures for a deck loaded onto platform 212 and to execute protocols for components loaded into carousel 204 and reaction vessel 205 and loaded onto the deck within housing 202. In order for controller 214 to perform one or more sequences of steps on a set of vials loaded into carousel 204 and reaction vessel 205 per the protocol, controller 214 should know the physical location of each vial within carousel 204 and reaction vessel 205, as well as the contents of each vial at each location within carousel 204 and reaction vessel 205. As discussed herein, controller 214 can be configured to operate transport device 141 to contact platform 212 or a deck disposed thereon, with mandrel 254 or framing tip 258 (FIG. 3) coupled thereto to perform various framing procedures. Furthermore, controller 214 can be configured to operate transport device 141 to contact labware loaded onto the deck to verify the loading and proper positioning of the labware thereon. The contact information read from these locations, e.g., via a sensor in control computer 108 (FIG. 1) electronically coupled to mandrel 254, can be compared to information, such as information obtained from network 216 or stored in a computer readable medium, such as medium 108B of FIG. 1. The information stored in the computer readable medium can include expected, general location information for deck 220 on platform 212, including receptacles 300, 302, 304 and 306 attached thereto, and labware intended to be loaded thereon. For example, the stored information can comprise intended location information for specific portions or features of receptacles 300, 302, 304 and 306 as well as complete geometric information (e.g., dimensions, sizes, tolerances, etc.) for receptacles 300, 302, 304 and 306 and pieces of labware that can be positioned within each of receptacles 300, 302, 304 and 306. As such, controller 214 can compare the expected, general locations with the actual locations read during the framing procedures described herein to register the location of deck 220 to transport device 141, and then extrapolate the position of the remainder of each of receptacles 300, 302, 304 and 306 and labware that can be stored therein. Thus, as will be discussed in greater detail below, transport device 141 can be used to contact receptacle 232, and labware piece 230 when located in receptacle 232, to find the position of receptacle 232, and piece 230, relative to deck 220.

FIG. 3 a schematic diagram illustrating platform 212 of FIGS. 4 and 5 with labware piece 230 positioned within receptacle 232 of deck 220 and positioned relative to transport device 141 and imaging device 206. Transport device 141 can comprise an overhead crane system having rails 240A and 240B that run across a length of platform 212 and bridge 242 that can span the width of platform 212. Bridge 242 can be configured to slide on rails 240A and 240B, such as via wheels 244A and 244B. Carriage 246 can be coupled to bridge 242 and can be configured to move along bridge 242 across the width of platform 212. Bridge 242 and carriage 246 can be operatively coupled to one or more motors 248 and power sources (not shown), as well as control panel 214 (FIG. 2) or control computer 108 (FIG. 1), to move according to a framing procedure or protocol. Carriage 246 can comprise trolly 250 having wheels 252A and 252B, mandrel 254 and tip socket 256. Mandrel 254 can be coupled to one or more instruments for performing a framing procedure or protocol. In the illustrated example, tip socket 256 is coupled to framing tip 258. In examples, framing tip 258 can be configured to move axially in the Z direction via telescoping action of mandrel 254, carriage 246 can be configured to move axially in the X direction on bridge 242, and bridge 242 can be configured to move axially in the Y direction on rails 240A and 240B. As such, framing tip 258 can be moved to engage receptacle 232 and labware piece 230 and move liquid to and from labware piece 230 from other locations on deck 220. Motor 248 can comprise one or more motors for moving trolly 250 by activating wheels 252A and 252B, moving bridge 242 by activating wheels 244A and 244B, and moving tip socket 256 relative to mandrel 254, such as by moving a linear actuator. Motor 248 can comprise a stepper motor wherein the position of a component of motor 248 relative to the rest of motor 248 can be translated into an X, Y, or Z position in the coordinate system.

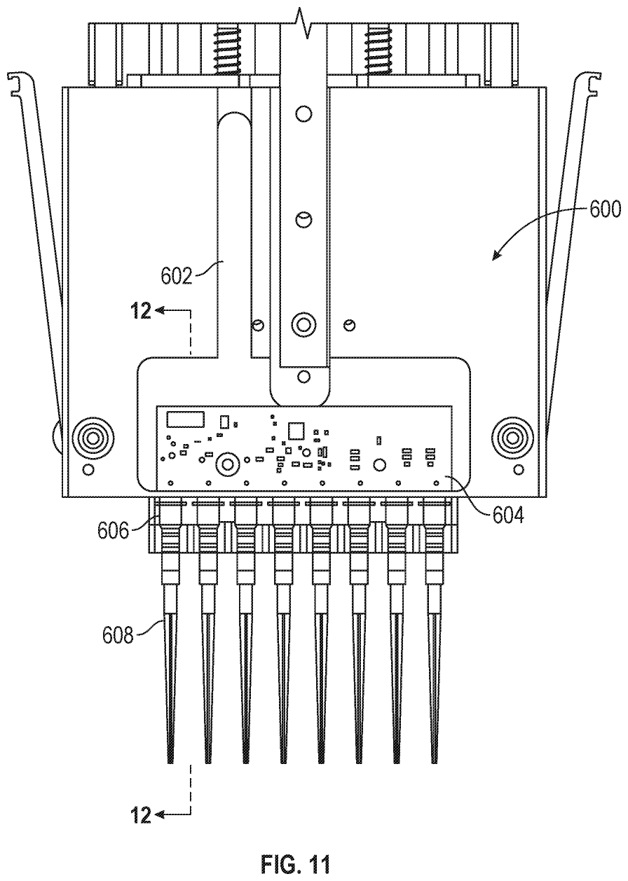

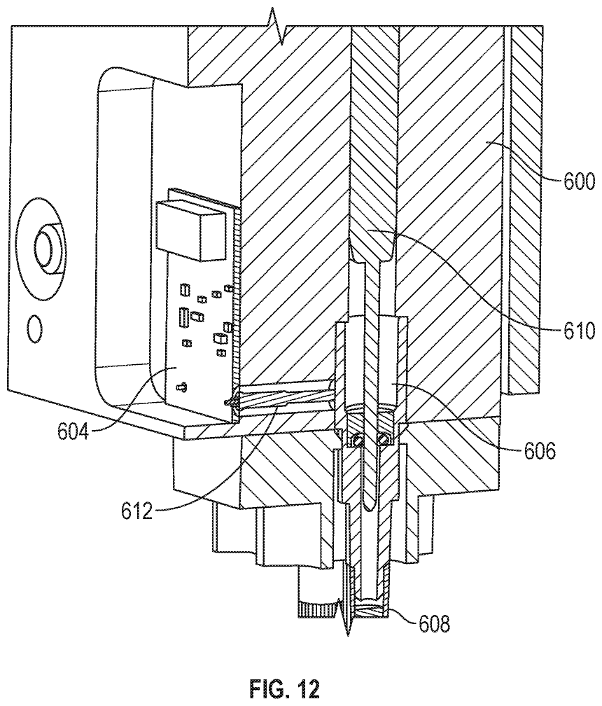

According to the present disclosure, transport device 141 can be operated by controller 214 to engage a tip of framing tip 258 or tip socket 256 of mandrel 254 if framing tip 258 is not installed in tip socket 256 to engage features of deck 220, such as to execute framing procedures described herein. Mandrel 254, tip socket 256 extending therefrom, and framing tip 258, as well as other conducting or semi-conducting instruments attached to tip socket 256, can be configured to be in electrical communication with an impedance-based sensor located, for example, in controller 214 (FIG. 2), carriage 250, mandrel 254, or another location in or on housing 202. In an example, mandrel 254 and the associated impedance-based sensor can be configured as mandrel 606 and capacitance sensor 616 of FIGS. 11 and 12. In examples, the capacitance sensor can comprise a CapSense® sensor from Cypress Semiconductor. In additional examples, pipette tips attached to tip socket 256 can be fabricated from plastic infused or embedded with conducting material. In some examples, the conducting material can be transparent. In some examples, the conducting material includes indium tin oxide. Inherent structural features of receptacle 232 that are fixedly attached to deck 220 can be contacted and the location of tip socket 256 in three-dimensional X, Y, Z coordinates can be recorded so that controller 214 can know the location of receptacle 232 and labware piece 230 located therein. For example, receptacle 232 can include walls 234A, 234B, 234C and 234D that can intersect at corners and can thus form a plurality of landmarks that be engaged by tip socket 256 for registration against locations stored in computer readable medium 108B.

The general locations for receptacle 232, and piece 230 when disposed thereon, can be stored in computer readable medium 108B. The general locations can be in the form of an (X, Y, Z) coordinate for a particular feature of receptacle 232 and piece 230. Computer readable medium 108B can additionally include stored therein the shapes of receptacle 232 and piece 230 such that from the location for the particular feature, the locations for the remainder of the geometry of receptacle 232 and piece 230 can be determined, e.g., built out from the particular features. The general locations can comprise a location where computer controller 108 and transport device 141 can expect to find receptacle 232 and piece 230. However, due to variations from machine to machine due to manufacturing and assembly tolerances, as well as shipping and user set-up variations, the exact location may be different from machine to machine. As such, computer controller 108 can execute the framing processes described herein to search for the specific location of receptacle 232 and piece 230 in the area of the general location. Then, the found or specific location for the (X, Y, Z) coordinate of the particular feature for receptacle 232 can be compared to a general location for the (X, Y, Z) coordinate for the particular feature of receptacle 232. Thus, the location for the general location of receptacle 232 can be offset or compensated using the found or specific location for the (X, Y, Z) coordinate of the particular feature for receptacle 232.

FIG. 4 is plan view of deck 220 for loading onto platform 212 of housing 202 of FIG. 2 with labware loaded thereon. FIG. 5 is a plan view of deck 220 of FIG. 3 without the labware loaded thereon. Unless specifically noted otherwise, FIGS. 4 and 5 are discussed concurrently.

Deck 220 can include spaces or locations L1-L16 for various components, including carousel 204, reaction vessels 205, pipette tip racks 218, milli-tip racks 221, bulk reservoirs 222 and waste bin 224. Other locations can be provided for other items of labware, such as tube holders and reagent tube holders.

One or more imaging devices 206 can be mounted within housing 202 relative to platform 212 such that imaging device can produce a field of view that covers all of platform 212. Likewise, a transport system, such as transport device 141 of FIGS. 1 and 3, can be configured to move mandrel 254 around the entirety of platform 212.

FIG. 4 shows deck 220 including locations numbered L1-L16, as well as other components such as thermocycler system 208, which can operate as a separate location for separate types of components or packages of components. Examples of deck 220 can have additional locations or fewer locations, as desired. While these locations can be numbered or named, the locations may or may not be physically labeled or marked on deck 220 in physical embodiments of fluid handling system 200. In examples of fluid handling system 200, some or all of the locations can be occupied by a pre-defined type of component according to a certain protocol. For example, locations L1-L4 can comprise storage locations for pipette tip racks 218 and location L5-L10 can comprise storage locations for milli-tip racks 221 that can be loaded with a component of a package or reagent kit or a component as specified by a protocol, and location L11 can be loaded with carousel 204. Racks 218 and 221 can comprise instances of reaction vessel 205. Location L12 can comprise a cold reagent storage area for reaction vessels 205. Location L13 can comprise a warm reagent storage area for reaction vessels 205. Location L14 can comprise a storage area for bulk reservoirs 222. Location L15 can comprise an RV stack storage area for reaction vessels 205. Locations L14 and L15 can be interchanged. Location L16 can comprise a waste storage area for bin 224. Some of locations L1-L16 can include the same type of component. The components can comprise test tubes, microwell or microtiter plates, pipette tips, plate-lids, reservoirs or any other suitable labware component. The components can also comprise an item of laboratory equipment, such as a shaker, stirrer, mixer, temperature-incubator, vacuum manifold, magnetic plate, thermocycler, or the like.

In examples, one or more locations can be physically part of structure 140 (FIG. 1), housing 202 (FIG. 2) or deck 220 (FIG. 3), or can be a separate component disposed on (and affixed to) platform 212. Each of locations L1-L16 can be accessed by transport device 141 (FIG. 1). For example, locations L1-L16, and thermocycler 208 can be physically separate from structure 140 or deck 220. As shown in FIG. 5, locations L1-L16 can comprise, sockets, slots or receptacles into which other components, e.g., labware, can be positioned and held stationary in known locations relative to transport device 141.

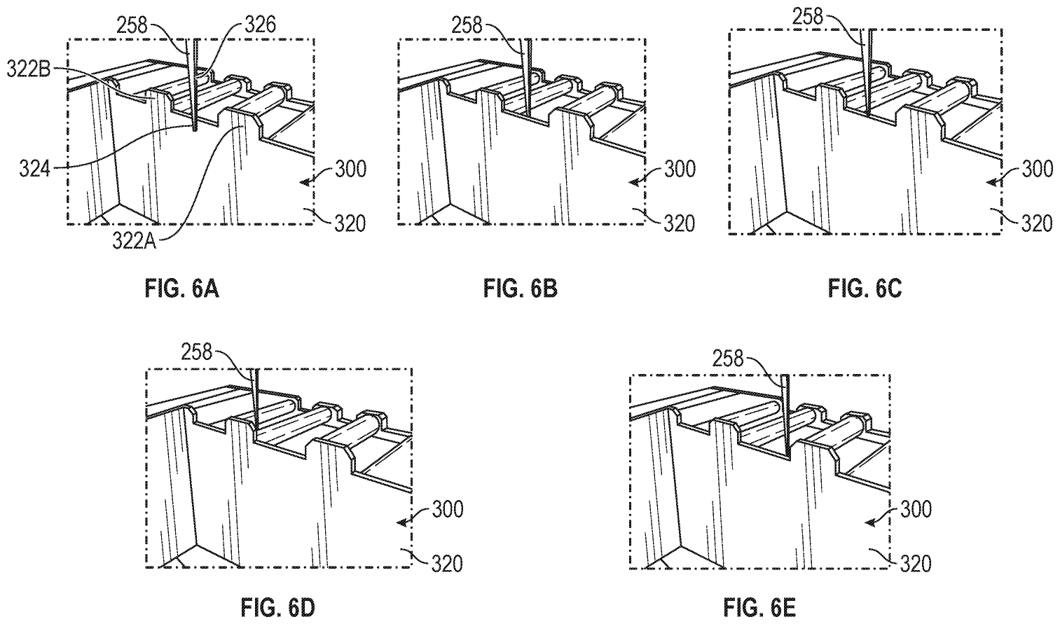

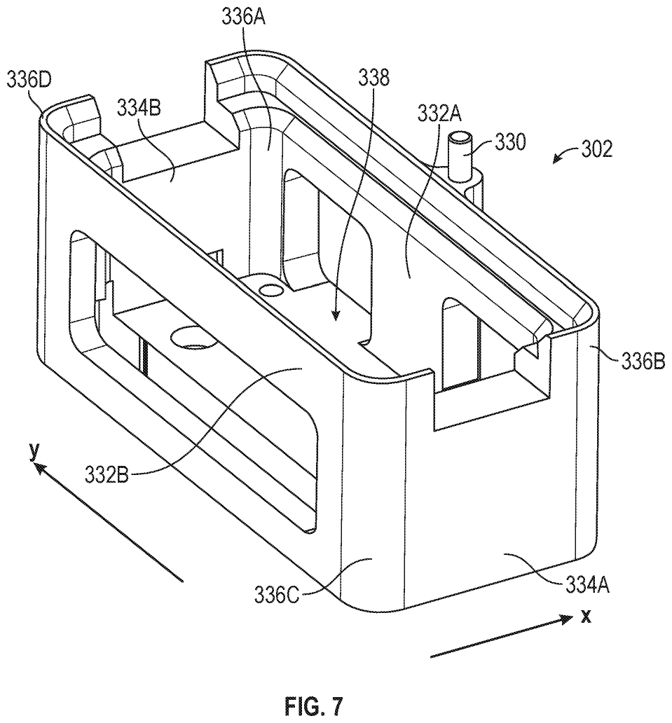

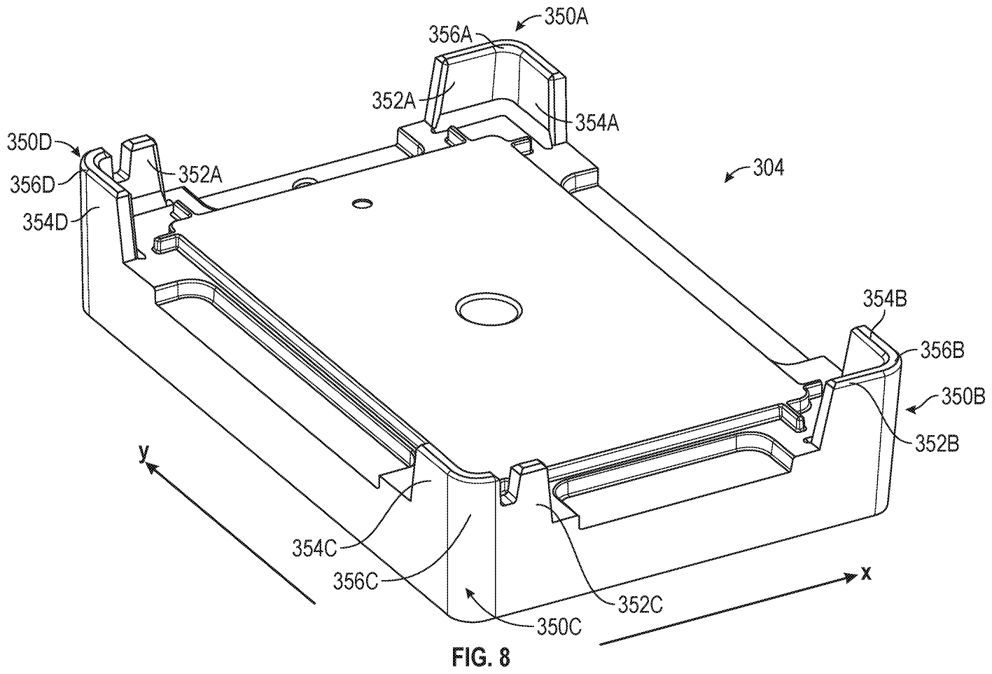

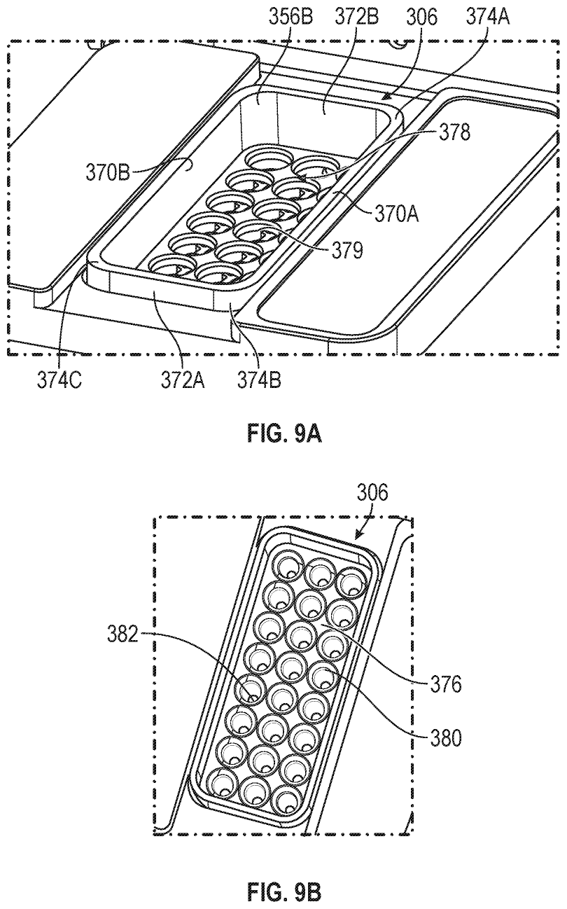

For example, bulk reservoirs 222 (FIG. 3) can be positioned in bulk reservoir holder 300 (FIGS. 5 and 6), reaction vessel 205 (FIG. 3) can be positioned in labware holder 302 (FIG. 7), milli-tip racks 221 (FIG. 3) can be positioned in rack holder 304 (FIG. 8) and thermocycler reservoir 205T (FIG. 3) can be positioned in thermocycler reservoir holder 306 (FIG. 9).

Imaging device 206 can be configured to recognize the presence of one or more components at each of locations L1-L16 the presence of carousel 204 at location L11 and the presence of reaction vessel 205 at locations L12, L13 and L14, for example. Furthermore, imaging device 206 can be configured to read information from the one or more components located at each of locations L1-L16. Components, e.g., vials of liquid, can be loaded into carousel 204 is a desired manner, e.g., according to a protocol and liquid therefrom, or another location, can be loaded into one of reaction vessels 205 for loading into thermocycler system 208 according to the protocol. Images of reaction vessel 205 taken by imaging device 206 can be used to read information from labels of vials loaded into reaction vessel 205. Thereafter, thermocycler system 208 can executing a heating method to heat the liquid loaded into reaction vessel 205 according to the protocol. Imaging device 206 can be used to identify a component loaded onto deck 220 and verify that the identified component is the expected component. In further examples, imaging device 206 can indicate that a component other than the expected component has been loaded, or that the expected component has been loaded improperly (such as crooked). In examples, the framing process can be used to confirm the presence, shape and proper loading of the component.

FIGS. 6A-6E are perspective views of framing tip 258 of transport device 141 of FIG. 3 engaging features of bulk reservoir holder 300 of FIG. 5 in performing a framing process. Bulk reservoir holder 300 can comprise wall 320 and flanges 322A and 322B. Framing tip 258 can comprise tip 324 and shaft 326. As shown in FIGS. 6A-6E, framing tip 258 can be put through a sequence of movements to zero in on a specific location for flanges 322A and 322B, for example, to determine the exact X, Y, Z coordinates for all of bulk reservoir holder 300. In some examples, framing tip 258 can comprise the end of a liquid aspirating and/or dispensing probe coupled to the transport device 141. In other examples, the framing tip 258 can comprise mandrel 606 of a pipettor coupled to the transport device, and/or a pipette tip 608 reversible coupled to the mandrel 606.

Wall 320 can comprise a sheet metal structure against which bulk reservoir container 222 can be positioned. Wall 320 can be made of conducting materials. Wall 320 can be part of a four-sided structure into which bulk reservoir container 222 can fit for precise placement relative to deck 220. Flanges 322A and 322B of wall 320 can interact with bulk reservoir container 222 to secure bulk reservoir container 222 in place within bulk reservoir holder 300. Flanges 322A and 322B be considered posts and can comprise inherent landmarks upon which a framing process can be executed to locate bulk reservoir holder 300. Framing tip 258 can be attached to mandrel 254 to frame bulk reservoir holder 300. Framing tip 258 can be slowly moved into contact with wall 320, such is the first through fifth steps described below, to take position readings, such as by sensing capacitance with a capacitance sensor located in control computer 108 (FIG. 1) in electronic communication with framing tip 258.

During a first step, tip 324 of framing tip 258 can be contacted to a back (exterior) edge of wall 320, as shown in FIG. 6A. During a second step, tip 324 of framing tip 258 can be contacted to a front (interior) side of wall 320, as shown in FIG. 6B. Framing tip 258 can be kept along a straight line on either side of wall 320 to define a Y-axis location. The front and back sides of wall 320 can be used to find a top of wall 320. During a third step, the top (superior) side of wall 320 can be contacted by tip 324 of framing tip 258, as shown in FIG. 6C. The top of wall 320, along the defined Y-axis, can be used to define an X-axis location. Flanges 322A and 322B can be used to find an X-axis. During a fourth step, wall 320 can be contacted on an inner side of flange 322B, a side that faces flange 322A, as show in in FIG. 6D. During a fifth step, wall 320 can be contacted on an inner side of flange 322A, a side that faces flange 322B, as shown in FIG. 6E. Thus, the top of wall 320 can define the X-axis and the mid-way position between flanges 322A and 322B can be used to define an X-axis location. As such, X, Y and Z coordinates for bulk reservoir holder 300 can be found using structure integral to bulk reservoir holder 300 that is attached to deck 220.

Additional inherent landmarks on bulk reservoir holder 300 can be found on walls opposing wall 320. For example, three inherent landmarks can be found so that the three-dimensional orientation of bulk reservoir holder 300 relative to deck 220 can be defined.

The actual locations of inherent landmarks on bulk reservoir holder 300 can be compared to the general or expected location for the inherent landmarks of bulk reservoir holder 300 stored in computer readable medium 108B. For example, the general location for the inherent landmark found in the first through fifth steps described above for bulk reservoir holder 300 can correspond to point on top of wall 320 midway between flanges 322A and 322B, as well as the general locations for other pre-defined landmarks on bulk reservoir holder 300 and can correspond to points on bulk reservoir holder 300 that match where those points should be located on deck 220 based on manufacturing specifications. The stored general locations can be compared to the found actual locations and the actual location of bulk reservoir holder 300 can be stored in computer readable memory 108B. Thus, the geometric shape of bulk reservoir holder 300 stored in computer readable memory 108B can be built out from the actual locations of the inherent landmarks found with framing tip 258. That is, (X, Y, Z) coordinates for the physical geometry of bulk reservoir holder 300 can be determined, and the (X, Y, Z) coordinates for the physical geometry of bulk reservoir container 222 can be built out from the actual location of bulk reservoir holder 300, so that control computer control 108 can know where to move mandrel 254 to allow a tool, such as a pipettor, loaded into mandrel 254 to interact with bulk reservoir container 222.

FIG. 7 is a perspective view of labware holder 302 for reaction vessels 205 and cylindrical post 330 located proximate labware holder 302 upon which a framing process can be conducted. Labware holder 302 can comprise elongate walls 332A and 332B, end walls 334A and 334B, and rounded corners 336A-336D. Walls 332A and 332B and walls 334A and 334B can be joined at floor 336 to form receptacle 338.

Labware holder 302 can comprise a rectangular receptacle 338 having opposing walls jointed by rounded corners. In examples, labware holder 302 can be fabricated from a conducting material, such as metal or plastic coated or infused with capacitive or conducting particles. The conducting material can be transparent, such as indium tin oxide. The conducting material can form or comprise an outer conductive coating on the pipette tip. In addition, components that can be sensed by the systems of the present disclosure can additionally be comprised of a non-conducting material combined with an added conducting material. For example, sensed component, such as items of labware, can comprise a plastic material with a conducting material added thereto, such as via coating, embedding or infusing. In further examples, inherent landmarks of deck 220 can be comprised of non-conductive plastic with conductive material added thereto. The location of labware holder 302 can be found by inserting framing tip 258 into the expected center of the opening of receptacle 338 formed by walls 332A, 332B, 334A and 334B. The opening formed by the center of the receptacle can comprise a safe place into which framing tip 258 can be inserted to be in position to later contact walls without crashing into walls 332A, 332B, 334A and 334B prematurely due to walls 332A, 332B, 334A and 334B being in an unexpected location. From within the opening at a safe Z direction depth, framing tip 258 can be moved in X and Y directions to safely contact walls 332A, 332B, 334A and 334B. Framing tip 258 can be slowly moved into contact with labware holder 302, such as described in steps 1a through 4b below, to take position readings, such as by sensing impedance with an impedance-based senor, such as a capacitance sensor located in control computer 108 (FIG. 1) in electronic communication with framing tip 258.

At step 1a, framing tip 258 can be moved to X and Y coordinates for an expected center of receptacle 338 between walls 332A-332D. At step 1b, framing tip 258 can be moved down to a safe clearance height above floor 336. At step 1c, framing tip 258 can be moved downward until tip 324 contacts floor 336. At step 1d, framing tip 258 can be moved up to a height approximately equal to the height of walls 332A, 332B, 334A and 334B.

Next, an X-axis for labware holder 302 can be found. At step 2a, framing tip 258 can be moved into a negative (−) X position to contact wall 332B. At step 2b, framing tip can be moved back to the expected center of receptacle 338. At step 2c, framing tip can be moved into a positive (+) X position to contact wall 332A. At step 2d, the average of the negative and positive X positions can be determined to find the center of receptacle 338. At step 2e, framing tip 258 can be moved to the calculated center of opening in the X direction.

Next, a Y-axis for labware holder 302 can be found. At step 3a, framing tip 258 can be moved into a negative (−) Y position to contact wall 334A. At step 3b, framing tip can be moved back to the expected center of receptacle 338. At step 3c, framing tip 258 can be moved into a positive (+) Y position to contact wall 334B. At step 3d, the average of the negative and positive Y positions can be determined to find the center of receptacle 338. At step 3e, framing tip 258 can be moved to the calculated center of opening in the Y direction.

At step 4a, framing tip 258 can be moved to the (X, Y) center of receptacle 338 to find the Z coordinate. At step 4b, any of the steps 1a to 3e can be repeated in an iterative process to find the location of labware holder 302, depending on how far the calculated location was from the expected location. The center of labware holder 302 can comprise an inherent landmark from which to reference the general or expected location of labware holder 302 stored in computer readable medium 108B.

A second inherent landmark can be found at post 330 such that the center of receptacle 338 and post 330 can be used to orient the physical of geometry of labware holder 302 relative to deck 220. A framing procedure for post 330 can be conducted by moving framing tip 258 through the following procedures:

At step 1, seek left side of post 330. At step 1a, move framing tip 258 to expected Y-axis position of post 330. At step 1b, move end of tip 324 to left of expected position. At step 1c, move slightly tip 324 below top of expected position. At step 1d, seek to the right to find left side of post 330. At step 1e, back away from post 330.

At step 2, seek right side of post 330. At step 2a, move up to clear post 330. At step 2b, move end of tip 324 to the right of expected position. At step 2c, move slightly below expected position. At step 2d, seek to the left to find right side of post 330. At step 2e, back away from post 330.

At step 3, calculate X-axis position of post 330. At step 3a, average left and right seek positions of post 330.

At step 4, seek front side of post 330. At step 4a, move up to clear post 330. At step 4b, move to calculated X-axis position of post 330. At step 4c, move end of tip 324 to front of expected position. At step 4d, move slightly below expected position. At step 4e, seek toward the back to find front side of post 330. At step 4f, back away from post 330.

At step 5, seek back side of post 330. At step 5a, move up to clear post 330. At step 5b, move end of tip behind expected position. At step 5c, move slightly below expected position. At step 5d, seek toward front to find back side of post 330. At step 5e, back away from post 330.

At step 6, calculate Y-axis position of post 330. At step 6a, average back and front seek positions of post 330.

At step 7, seek top side of post 330. At step 7a, move up to clear post 330. At step 7b, move to calculated X-axis position of post 330. At step 7c, move to calculated Y-axis position of post 330. At step 7d, move slightly above expected position. At step 7e, seek downward to find top side of post 330. At step 7f, back away from post 330.

At step 8, return calculated X-axis, Y-axis, and Z-axis positions of post 330.

At step optional step 9, repeat steps above depending on deviation from calculated post location from initial guess.

The actual locations of inherent landmarks on labware holder 302 can be compared to the general or expected location for the inherent landmarks of labware holder 300 stored in computer readable medium 108B. For example, the general locations for the center of labware holder 302 and post 330 can comprise inherent landmarks, as discussed above, that can correspond to points on labware holder 302 that match where those points should be located on deck 220 based on manufacturing specifications. The stored general locations can be compared to the found actual locations and the actual location of labware holder 302 can be stored in computer readable memory 108B. Thus, the geometric shape of labware holder 302 stored in computer readable memory 108B can be built out from the actual locations of the inherent landmarks found with framing tip 258. That is, (X, Y, Z) coordinates for the physical geometry of labware holder 300 can be determined, and the (X, Y, Z) coordinates for the physical geometry of reaction vessel 205 can be built out from the actual location of labware holder 300, so that control computer control 108 can know where to move mandrel 254 to allow a tool, such as a pipettor, loaded into mandrel 254 to interact with reaction vessel 205.

FIG. 8 is a perspective view of labware holder 304 for tip boxes or microplates upon which a framing process can be conducted. Labware holder 304 can comprise corner walls 350-350D. Each of walls 350A-350D can include an wall segment extending in the X direction, a rounded corner piece and a wall segment extending in the Y direction. Wall 350A can comprise x-wall 352A, y-wall 354A and corner 356A. Wall 350B can comprise x-wall 352B, y-wall 354B and corner 356BA. Wall 350C can comprise x-wall 352C, y-wall 354C and corner 356C. Wall 350D can comprise x-wall 352D, y-wall 354D and corner 356D. Labware holder 304 can be framed using a similar procedure as outlined with reference to labware holder 302 in FIG. 7. For example, framing tip 258 can be moved into the center of the receptacle formed between walls 350A-350D, and then moved in X and Y directions to find each of walls 350A-350D. Each of walls 350A-350D can be used as an inherent landmark to determine the actual three-dimensional orientation of labware holder 304 relative to the general location of labware holder 304 stored in computer readable medium 308B.

FIGS. 9A-9B are perspective views of thermocycler reservoir holder 306 upon which a framing process can be conducted. Thermocycler reservoir holder 306 can comprise elongate walls 370A and 370B, end walls 372A and 372B, and rounded corners 374A-374D. Walls 370A and 370B and walls 372A and 372B can be joined at plate 376 to form receptacle 378. As shown in FIG. 9B, thermocycler reservoir holder 306 can comprise a two-level receptacle, with plate 376 having openings 379 through which vial can be extended. Below plate 376 are located sockets 380 having bottoms 382. Similar framing procedures described above for labware holder 302 can be used to locate walls 370A-372B.

Additionally, bottoms 382 of sockets 380 can be found using a similar, albeit inverse, procedure as described for post 330, except rather than finding sides of a cylindrical body, sides of a cylindrical opening can be found. For example, finding the center of a circular post involves seeking inward toward a center, while finding the center of a socket involves seeking out towards cylindrical walls.

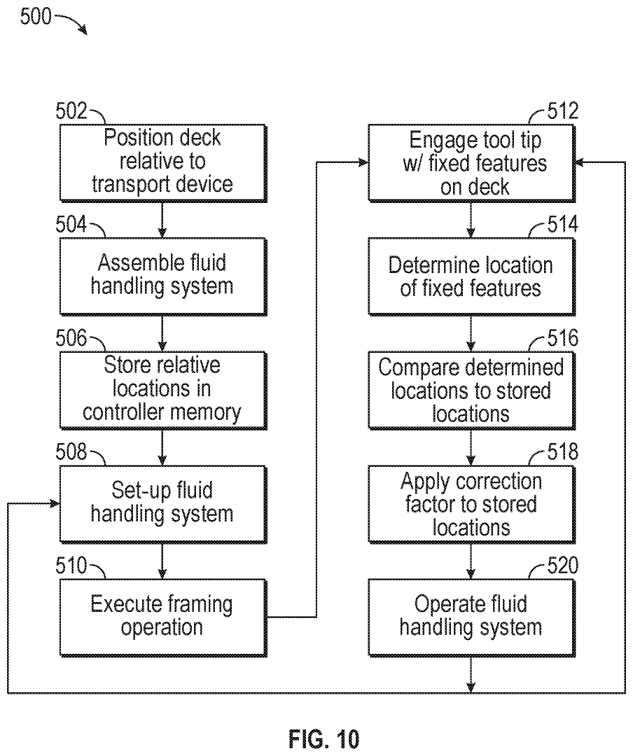

FIG. 10 is a line diagram illustrating steps of method 500 for framing a workspace of a deck (e.g., deck 220) of the fluid handling system 100 and 200 of FIGS. 1 and 2, respectively.

At step 502, deck 220 can be positioned relative to transport device 141. Thus, the relative position of deck 220 and rails 240A and 240B of transport device 141 can be fixed. Thus, with the position of bridge 242 being known relative to rails 240A and 240B, the position of carriage 250 on bridge 242 relative to transport device 141 can also be determined. For example, a stepper motor or an encoder can be used to log the position of carriage 250 relative to bridge 242 and bridge 242 relative to rails 240A and 240B.

At step 504, fluid handling system 200 can be assembled. For example, deck 220 can be positioned on platform 212 within housing 202, and transport device 141 can be positioned within housing 202. The components can be fastened together according to manufacturer assembly instructions.

At step 506, the relative locations between transportation device 141, e.g. rails 240A and 240B, housing 202, platform 212 and deck 220 can be stored in computer readable medium 108B. These general or expected locations can be used to by control computer 108 for comparison to actual locations found using the framing procedures described herein to determine variations from the expected manufactured assembly state.

At step 508, fluid handling system 200 can be set-up for operation. That is, an end-user can install fluid handling system 200 in a laboratory or another location for use. Thus, housing 202 and platform 212 can be disposed on a work surface. The worksurface may or may not be level or at the same inclination based on factory settings. As such, the assembly of fluid handling system 200, as conducted at step 504 may be different. Furthermore, shipping and handling of fluid handling system 200 from assembly at step 504 to the location of step 508 may additionally jostle or inadvertently rearrange the assembly of housing 202, platform 212, deck 220 and rails 240A and 240B. Furthermore, manufacturing tolerances may shift the actual locations of said components from the expected manufactured assembly state, such as due to tolerance stacking. Thus, even though a fluid handling system can be manufactured according to suitable specifications, it might be desirable to shift the expected location of deck 220 to better facilitate interaction of deck 220 with transport device 141.

At step 510, framing operations of deck 220 can be conducted. For example, any of the procedures described herein, such as those described with reference to FIGS. 6-9 can be executed by control computer 108.

At step 512, computer controller 108 can access instructions stored in computer readable medium 108B to operate transport device 141 to move mandrel 254, or a tool attached thereto, to contact various features of deck 220.

At step 514, measurements of mandrel 254, or a tool attached thereto, can be taken relative to an (X, Y, Z) coordinate system of the workspace of housing 202 and platform 212 to determine the location of transport device 141 relative to deck 220. The measurements can, in examples, be taken by sensing capacitance at mandrel 254 using a capacitance sensor connected to control computer 108.

As such, framing procedures can be conducted by control computer 108. Control computer 108 can move mandrel 254 to touch tip socket 256, framing tip 258 attached to tip socket 258 or a pipette attached to tip socket 256 to various locations on deck 220. The locations of deck 220 can interact with mandrel 254, such as by allowing mandrel 254 (or tools attached thereto) to read the capacitance, resistance, inductance, or any other suitable impedance-based electrical property at that location using an impedance-based sensor located away from mandrel 254 at control computer 108. The impedance-based readings can be correlated to an X, Y, Z location for a center axis of mandrel 254 in the three-dimensional workspace above deck 220, as defined by X-coordinate movements of carriage 250 on bridge 242, Y-coordinate movements of bridge 242 on rails 240A and 240B and Z-coordinate movements of tip socket 256 relative to mandrel 254 (e.g., telescoping action of mandrel 254), such as via the use of stepper motors, encoders, counters and the like.

At step 516, the location measurements of mandrel 254 taken at step 514 can be compared to coordinate locations stored in computer readable medium 108B, such as those stored at step 506.

At step 518, a correction factor can be applied to the locations of deck 220 stored in computer readable medium 108B based on the measured coordinate locations determined at step 516. The correction factor can adjust the known location of deck 220 for control computer 108 so that control computer 108 knows where to move carriage 250 to allow mandrel 254 to interact with labware located on deck 220

At step 520, fluid handling system 200 can be operated to, for example, conduct library construction processes described herein.

After step 520, method 500 can move back to step 508 to set-up fluid handling system 200, such as to conduct a new library construction process or after fluid handling system 200 has been moved to a different location, or method 500 can move back to step 508 repeat the framing process, such before conducting another library construction process.

FIG. 11 is a perspective view of manifold 600 that can be coupled to transport device 141. In examples, manifold 600 can be connected to carriage 250 to be mobile within the workspace of fluid handling system 200 (FIG. 2). Manifold 600 can include various cables and connectors for electronically coupling manifold and components thereof to controller 214. For example, manifold 600 can comprise cable 602 that can connect circuit board 604 to controller 214. Mandrel 606 can be connected to manifold 600, which can include spaces to couple to multiple pipette tips 608. In the illustrated example, manifold 600 can hold 8 pipette tips 608.

FIG. 12 is a cross-sectional view of manifold 600 of FIG. 11 taken at section 11-11 showing circuit board 604, mandrel 606, pipette tip 608, plunger 610 and connector pin 612. FIGS. 11 and 12 are discussed concurrently.

Mandrel 606 can comprise a device to which pipette tips 608 can be connected. In examples, mandrel 254 of FIG. 3 can be configured similarly to mandrel 606. Mandrel 606 can include sealed cap 614 through which shaft 616 of plunger 610 can be extended. Plunger 610 can be activated by manifold 600, such as via controller 214, to draw a vacuum within pipette tip 608, similar to a syringe. As such, transport device 141 can move mandrel 606 around the workspace to that pipette tips 608 can be inserted into a volume of liquid, plunger 610 can be retracted (moved upward with reference to FIG. 12) to draw liquid into pipette tip 608 and moved to another position to dispense the liquid by downward movement of plunger 610.

Circuit board 604 can comprise a liquid level sensor board that is configured to sense capacitance. As such circuit board 604 can comprise capacitance sensor 616 that can be in electronic communication with connector pin 612. Connector pin 612 can provide an electrical connection between mandrel 606 and pipette tip 608 coupled thereto. In an example, connector pin 612 can comprise a pogo pin. For example, capacitance sensor 616 can be used to sense the level of liquid within a vial or container into which a pipette tip is inserted into, as can be appreciated by one of skill in the art. Furthermore, capacitance sensor 616 can be used to sense the position of mandrel 606 when contacted to a conducting surface, such as one of the inherent landmarks discussed herein. For example, mandrel 606 can be contacted to an inherent landmark such that capacitance sensor 616 can register a location of carriage 250, bridge 242 (FIG. 3), within the three-dimensional workspace. Additionally, if a conductive pipette tip 608 is coupled to mandrel 606, capacitance sensing can be conducted using pipette tips 608. Moreover, if the conductive pipette tip includes or is coated with transparent conductive material, such as indium tin oxide, then the pipette tip may be transparent, allowing the tip to be used for liquid-level sensing and/or deck-framing, while also allowing a user to see and confirm proper uptake and dispensing of liquid in the pipette tip during use. This is an advantage over conductive tips in the prior art, which are typically opaque and do not allow a user to see or confirm liquid levels in the tip.

As can be seen in FIG. 12, manifold 600 can further comprise gripper arms 618A and 618B, which can be coupled to manifold 600 at pivot points 620A and 620B, respectively. Gripper arms 618A and 618B can include gripping features 622A and 622B, respectively, such as teeth, flanges or fingers that can couple to an item of labware. For example, gripping features 622A and 622B can latch onto an edge of an item of labware so that transport device 141 can be used to move the item of labware around the workspace. Gripper arms 618A and 618B can be electronically coupled to capacitance sensor 616.

Incorporating capacitance sensor 616 into manifold 600 to be in electric communication with mandrel 606 can allow for configurations that facilitate execution of various features described herein, including framing of a workspace and items of labware loaded thereon. In additional examples, capacitance sensor 616 and mandrel 606, as well as other configurations, can allow for 1) measuring pipette tip offset relative to the mandrel, and 2) framing of gripping arms 618A and 618B.

In some examples, the calibrated position of mandrel 254 or mandrel 606 can be determined by capacitance sensing, as described herein. However, the actual position of the end of a pipette tip, e.g., pipette tip 608, loaded onto the mandrel may still be uncertain based on imprecision or variance in the manufacturability of pipette tips 608, especially if a particular tip is bent or crooked. For example, instances of pipette tips 608 can be longer or shorter than each other due to manufacturing variance and each pipette tip 608, even if exactly equal in length, might not seat in mandrel 606 in the exact same position. This can lead to pipetting errors if the actual position of the end of the tip is different than the expected position. The present disclosure allows any given pipette tip used for pipetting on the system to be independently framed or calibrated to reduce these errors (i.e. independent of the calibrated position of the mandrel).

To measure and compensate for any tip-to-tip differences, capacitance sensors of the present disclosure can be used to account for variance in the size and dimensions of pipette tips 608. First, a fixed target, such as an inherent landmark described herein, can be sensed to define a deck datum target using bare mandrel 606 with no tip or tool installed. Next, pipette tip 608 can be loaded into mandrel 606 and can be used to frame additional features. The same deck datum target can then be framed using pipette tip 608 loaded into mandrel 606. The position of pipette tip 608 relative to the bare mandrel 606 can be used to quantify any errors from the expected tip location of pipette tip 6008. Other targets, e.g., items of labware or inherent landmarks, can be frame with pipette tip 608 loaded on mandrel 606. Then, the opposite of the calculated error can be applied to the output of framing operations using pipette tip 608. Thus, differences in the expected location of a generic or ideal pipette tip can be compared to the found or exact location of an actual or misshapen pipette tip. This can be used to minimize any error induced by the geometry of the actual pipette tip that may be misshapen or improperly loaded into the mandrel.

As shown above in FIGS. 11 and 12, some embodiments of the present disclosure can include a manifold, pipettor or liquid dispenser that includes multiple channels. Each of these liquid-conducting channels can be coupled to a different capacitance sensor, e.g., a separate instance of capacitance sensor 616, to allow independent framing or calibration of each channel. For example, each of pipette tips 608 shown in FIG. 11 can be electronically coupled to an instance of capacitance sensor 616 to allow for independent framing operations to be conducted with each pipette tip 608.

In some examples of the present disclosure, manifold can be provided with gripper arms 618A and 618B, as described above. The actual position of the centers of gripper arms 618A and 618B relative to the center of mandrels 606 (i.e., the center of the pipettor) can vary. The present disclosure can allow for the actual position of gripper arms 618A and 618B to be framed or calibrated relative to mandrel 606, (or the workspace) using capacitance sensing. In one example, each of gripper arms 618A and 618B can be framed by moving gripper arms 618A and 618B towards one of pipette tips 608 loaded onto mandrel 606. The position of the contact between gripper arms 618A and 618B relative to the known position of mandrel 606 can therefore be determined. Alternatively, each of gripper arms 618A and 618B can be electrically coupled to an instance of capacitance sensor 616 to determine a position of gripper arms 618A and 618B in a similar way that the position of mandrel 606 and pipette tips 608 are determined. In examples, the liquid dispenser can be a multichannel pipettor with a plurality of gripper arms or gripper fingers, where each pipette channel and each gripper are coupled to a separate capacitance sensor.

In additional examples of the present disclosure, framing of a deck, such as deck 220, can be conducted by sensing contact between a working tool of the robotic fluid handler, such as mandrel 254, and a capacitance sensor located at a fixed position on the deck, such as deck 220. For example, capacitance sensor 616 can be mounted on deck 220 so as to be in electronic communication with control panel 214. Sensor 616, in such a configuration, can be located on deck 220 in a fixed location that is known to control panel 214. In other examples, sensor 616, can be located in other positions in the workspace not on deck 220, such as mounted to housing 202. Mandrel 254 can be moved to contact sensor 616 within the workspace. The sensed point of contact can be used by control panel 214 to define the actual position of the feature of mandrel 254 making contact with sensor 616. Thus, the position of the other features, such as the inherent landmarks of deck 220, can be built-out in three-dimensional space. In additional examples, a plurality of sensors can be positioned within the workspace, with each sensor being located in a known position registered with control panel 214. A plurality of sensors can facilitate detection of contact by a tool, such as mandrel 254, that is severely out of calibration. The position of the contact between mandrel 254 and each of the sensors in an array of sensors can establish the actual position of the tool in the three-dimensional workspace. In some embodiments, framing of the liquid dispenser is done using a capacitance sensor electrically coupled to the dispenser, while another tool or component of the robotic liquid handler may be framed using a fixed capacitance sensor on the deck. For example, one instance of sensor 616 can be located on manifold 600 while another instance of sensor 616 is located on deck 220 such that framing, e.g., of the working tool and other components, can be conducted with one or both instances of sensor 616.

### EXAMPLES

Example 1 is a method of framing a workspace for a working tool of a robotic fluid handler, the method comprising: positioning a liquid dispenser within a workspace of the robotic fluid handler using a transport device; moving the liquid dispenser to a general location of a component of the workspace; contacting the liquid dispenser to multiple features of the component; detecting the contacting of the liquid dispenser to the multiple features using an impedance-based sensor electrically coupled to the liquid dispenser; determining a specific location for the general location based on contacting of the liquid dispenser to the multiple features; and registering the specific location to the workspace.

In Example 2, the subject matter of Example 1 includes, wherein the impedance-based sensor comprises a capacitance sensor.

In Example 3, the subject matter of Example 2 includes, wherein the liquid dispenser comprises a pipettor including a mandrel, wherein the capacitance sensor is electrically coupled to the mandrel, and wherein the contacting of the liquid dispenser to the multiple features is by the mandrel.

In Example 4, the subject matter of Example 3 includes, loading a pipette tip onto the mandrel, wherein the pipette tip is electrically coupled to the capacitance sensor via the mandrel; and determining a specific location of an additional component of the workspace based on contacting the pipette tip to multiple features of the additional component.

In Example 5, the subject matter of Examples 2-4 includes, wherein the liquid dispenser comprises: a pipette tip loaded onto a mandrel and electrically coupled to the capacitance sensor to detect the contacting of the liquid dispenser to the multiple features.

In Example 6, the subject matter of Example 5 includes, wherein the pipette tip comprises a plastic material with a conducting material added thereto.

In Example 7, the subject matter of Examples 3-6 includes, loading a framing tip onto the mandrel of the liquid dispenser of the robotic fluid handler, wherein the mandrel is configured to sense capacitance at the framing tip loaded onto the mandrel.

In Example 8, the subject matter of Examples 2-7 includes, wherein the liquid dispenser comprises a manifold having one or more rotatable gripper fingers configured to couple to an item of labware, wherein the detected contact is between at least one of the one or more rotatable gripper fingers and the multiple features.

In Example 9, the subject matter of Examples 1-8 includes, wherein the component is a receptacle for holding a piece of labware.

In Example 10, the subject matter of Example 9 includes, wherein at least one of the multiple features of the component comprises a wall of the receptacle.

In Example 11, the subject matter of Example 10 includes, wherein at least one of the multiple features comprises a flange extending from the wall.

In Example 12, the subject matter of Examples 9-11 includes, wherein at least one of the multiple features of the component comprises a corner of the receptacle.

In Example 13, the subject matter of Examples 9-12 includes, wherein at least one of the multiple features of the component comprises a pedestal of the receptacle.

In Example 14, the subject matter of Examples 9-13 includes, wherein the receptacle is configured to hold one of a bulk reservoir container, a labware container, a tube holder, a tip rack or microplate storage container, and a thermocycler reservoir container.

In Example 15, the subject matter of Examples 9-14 includes, determining a proper orientation of a piece of labware loaded into the receptacle.

In Example 16, the subject matter of Examples 1-15 includes, wherein the general location is programmed into a control panel of the robotic fluid handler.

In Example 17, the subject matter of Example 16 includes, wherein geometries of labware configured to be loaded into the workspace are programmed into the control panel of the robotic fluid handler.

In Example 18, the subject matter of Examples 16-17 includes, wherein registering the specific location to the workspace comprises determining x, y, and z coordinates in the workspace for the specific location.

In Example 19, the subject matter of Examples 16-18 includes, a motor configured to at least partially move the transport device; and an encoder configured to determine at least one directional parameter of the liquid dispenser in x, y, and z coordinates in the workspace from the motor.

In Example 20, the subject matter of Examples 16-19 includes, determining specific locations for a plurality of general locations of a deck of the workspace; comparing the specific locations to stored general locations; and determining an installation location of the deck in the workspace relative to a factory installation.

In Example 21, the subject matter of Examples 16-20 includes, moving the liquid dispenser to determine a first coordinate; moving a carriage of the transport device to which the liquid dispenser is mounted to determine a second coordinate; and moving a bridge of the transport device to which the carriage is mounted to determine a third coordinate.

Example 22 is a method of framing a workspace for a robotic fluid handler, the method comprising: using a transportation device to position a framing tool within the workspace of the robotic fluid handler; moving the framing tool to an expected starting location for a feature of the workspace that is pre-programmed into a controller of the robotic fluid handler; moving the framing tool into contact with the feature; sensing contact with the feature via an impedance-based sensor of the controller that is in electrical communication with the framing tool; calculating an actual location for the feature; and storing the actual location in the controller.

In Example 23, the subject matter of Example 22 includes, where moving the framing tool into contact with the feature comprises executing a series of movements of the framing tool to contact multiple surfaces of the feature to define a location of the feature in three-dimensional space relative to the transportation device.

In Example 24, the subject matter of Examples 22-23 includes, wherein the feature of the workspace is a feature of a labware holder that is attached to a deck of the workspace.

In Example 25, the subject matter of Example 24 includes, attaching a pipette tip onto the framing tool, such that the pipette tip is electrically coupled to the capacitance sensor; loading a piece of labware onto the labware holder that is attached to the deck of the workspace; contacting the pipette tip to a feature of the piece of labware; sensing the contact of the pipette tip to the feature of the piece of labware via the impedance-based sensor; calculating an actual location for the feature of the piece of labware based on the sensed contact; and verifying proper seating of the piece of labware in the robotic fluid handling system based on the calculated actual location for the feature of the piece of labware.

In Example 26, the subject matter of Examples 24-25 includes, mapping a three-dimensional geometry of the labware holder in the workspace based on the actual location.

In Example 27, the subject matter of Example 26 includes, mapping a three-dimensional geometry of a piece of labware loaded into the labware holder.

Example 28 is a robotic fluid handling system comprising: a controller; a stationary deck; a component attached to the deck; a transport device controlled by the controller to move in three-dimensional space; and a liquid dispenser configured to dispense liquid into a piece of labware attached to the deck, the liquid dispenser arranged and adapted to be moved in three-dimensional space by the transport device, the liquid dispenser comprising an impedance-based sensor, wherein the controller is configured to detect contact of the liquid dispenser with a plurality of features of the component of the deck based on the amount of impedance sensed by the impedance-based sensor, wherein the controller is further configured to determine a location of the component in three-dimensional space based on the detected contact with the plurality of features.

In Example 29, the subject matter of Example 28 includes, wherein the plurality of features includes an inherent feature of the component.

In Example 30, the subject matter of Examples 28-29 includes, wherein the component is a labware receptacle.

In Example 31, the subject matter of Example 30 includes, wherein the controller is further configured to determine a location, in three-dimensional space, of a piece of labware reversibly placed in the labware receptacle based on a detected contact of the liquid dispenser with a plurality of features of the piece of labware.

In Example 32, the subject matter of Example 28 includes, wherein the liquid dispenser comprises a pipette tip electrically coupled to the impedance-based sensor, wherein the controller is further configured to determine a location of an end of the pipette tip in three-dimensional space based on a detected contact of the pipette tip with a fixed target on the deck.

Example 33 is at least one machine-readable medium including instructions that, when executed by processing circuitry, cause the processing circuitry to perform operations to implement of any of Examples 1-32.

Example 34 is an apparatus comprising means to implement of any of Examples 1-32.

Example 35 is a system to implement of any of Examples 1-32.

Example 36 is a method to implement of any of Examples 1-32.

Example A. A method of framing a workspace for a working tool of a robotic fluid handler, the method comprising: positioning a liquid dispenser within a workspace of the robotic fluid handler using a transport device; moving the liquid dispenser to a general location of a component of the workspace; contacting the liquid dispenser to multiple features of the component; detecting the contacting of the liquid dispenser to the multiple features using an impedance-based sensor electrically coupled to the liquid dispenser; determining a specific location for the general location based on contacting of the liquid dispenser to the multiple features; and registering the specific location to the workspace.

Example B. The method of Example A, wherein the impedance-based sensor comprises a capacitance sensor.

Example C. The method of Example B, wherein the liquid dispenser comprises a pipettor including a mandrel, wherein the capacitance sensor is electrically coupled to the mandrel, and wherein the contacting of the liquid dispenser to the multiple features is by the mandrel, the method further comprising: loading a pipette tip onto the mandrel, wherein the pipette tip is electrically coupled to the capacitance sensor via the mandrel; and determining a specific location of an additional component of the workspace based on contacting the pipette tip to multiple features of the additional component.

Example D. The method of Example C, wherein the pipette tip comprises a plastic material with a conducting material added thereto.

Example E. The method of any one of Examples C and D, further comprising loading a framing tip onto the mandrel of the liquid dispenser of the robotic fluid handler, wherein the mandrel is configured to sense capacitance at the framing tip loaded onto the mandrel.

Example F. The method of Example B, wherein the liquid dispenser comprises a manifold having one or more rotatable gripper fingers configured to couple to an item of labware, wherein the detected contact is between at least one of the one or more rotatable gripper fingers and the multiple features.

Example G. The method of any one of Examples A-F, wherein the component is a receptacle for holding a piece of labware and wherein at least one of the multiple features of the component comprises a wall of the receptacle.

Example H. The method of Example G, wherein at least one of the multiple features comprises a flange extending from the wall, a corner of the receptacle, or a pedestal of the receptacle.

Example I. The method of any one of Examples G and H, wherein the receptacle is configured to hold one of a bulk reservoir container, a labware container, a tube holder, a tip rack or microplate storage container, and a thermocycler reservoir container.

Example J. The method of any one of Examples G-I, further comprising determining a proper orientation of a piece of labware loaded into the receptacle.

Example K. The method of any one of Examples A-J, wherein: the general location is programmed into a control panel of the robotic fluid handler; and geometries of labware configured to be loaded into the workspace are programmed into the control panel of the robotic fluid handler.

Example L. The method of Example K, wherein registering the specific location to the workspace comprises determining x, y, and z coordinates in the workspace for the specific location.

Example M. The method of Example L, further comprising: a motor configured to at least partially move the transport device; and an encoder configured to determine at least one directional parameter of the liquid dispenser in x, y, and z coordinates in the workspace from the motor.

Example N. The method of any one of Examples L and M, further comprising: determining specific locations for a plurality of general locations of a deck of the workspace; comparing the specific locations to stored general locations; and determining an installation location of the deck in the workspace relative to a factory installation.

Example O. A robotic fluid handling system comprising: a controller; a stationary deck; a component attached to the deck; a transport device controlled by the controller to move in three-dimensional space; and a liquid dispenser configured to dispense liquid into a piece of labware attached to the deck, the liquid dispenser arranged and adapted to be moved in three-dimensional space by the transport device, the liquid dispenser comprising an impedance-based sensor, wherein the controller is configured to detect contact of the liquid dispenser with a plurality of features of the component of the deck based on the amount of impedance sensed by theimpedance-based sensor, wherein the controller is further configured to determine a location of the component in three-dimensional space based on the detected contact with the plurality of features.

### Various Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of framing a workspace for a working tool of a robotic fluid handler, the method comprising:
positioning a liquid dispenser within a workspace of the robotic fluid handler using a transport device;
moving the liquid dispenser to a general location of a component of the workspace;
contacting the liquid dispenser to multiple features of the component;
detecting the contacting of the liquid dispenser to the multiple features using an impedance-based sensor electrically coupled to the liquid dispenser;
determining a specific location for the general location based on contacting of the liquid dispenser to the multiple features; and
registering the specific location to the workspace.

2. The method of claim 1, wherein the impedance-based sensor comprises a capacitance sensor.

3. The method of claim 2, wherein the liquid dispenser comprises a pipettor including a mandrel, wherein the capacitance sensor is electrically coupled to the mandrel, and wherein the contacting of the liquid dispenser to the multiple features is by the mandrel.

4. The method of claim 3, further comprising:
loading a pipette tip onto the mandrel, wherein the pipette tip is electrically coupled to the capacitance sensor via the mandrel; and
determining a specific location of an additional component of the workspace based on contacting the pipette tip to multiple features of the additional component.

5. The method of claim 2, wherein the liquid dispenser comprises:
a pipette tip loaded onto a mandrel and electrically coupled to the capacitance sensor to detect the contacting of the liquid dispenser to the multiple features.

6. The method of claim 5, wherein the pipette tip comprises a plastic material with a conducting material added thereto.

7. The method of claim 3, further comprising loading a framing tip onto the mandrel of the liquid dispenser of the robotic fluid handler, wherein the mandrel is configured to sense capacitance at the framing tip loaded onto the mandrel.

8. The method of claim 2, wherein the liquid dispenser comprises a manifold having one or more rotatable gripper fingers configured to couple to an item of labware, wherein the detected contact is between at least one of the one or more rotatable gripper fingers and the multiple features.

9. The method of claim 1, wherein the component is a receptacle for holding a piece of labware.

10. The method of claim 9, wherein at least one of the multiple features of the component comprises a wall of the receptacle.

11. The method of claim 10, wherein at least one of the multiple features comprises a flange extending from the wall.

12. The method of claim 9, wherein at least one of the multiple features of the component comprises a corner of the receptacle.

13. The method of claim 9, wherein at least one of the multiple features of the component comprises a pedestal of the receptacle.

14. The method of claim 9, wherein the receptacle is configured to hold one of a bulk reservoir container, a labware container, a tube holder, a tip rack or microplate storage container, and a thermocycler reservoir container.

15. The method of claim 9, further comprising determining a proper orientation of a piece of labware loaded into the receptacle.

16. The method of claim 1, wherein the general location is programmed into a control panel of the robotic fluid handler.

17. The method of claim 6, wherein geometries of labware configured to be loaded into the workspace are programmed into the control panel of the robotic fluid handler.

18. The method of claim 16, wherein registering the specific location to the workspace comprises determining x, y, and z coordinates in the workspace for the specific location.

19. The method of claim 16, further comprising:
a motor configured to at least partially move the transport device; and
an encoder configured to determine at least one directional parameter of the liquid dispenser in x, y, and z coordinates in the workspace from the motor.

20. The method of claim 16, further comprising:
determining specific locations for a plurality of general locations of a deck of the workspace;
comparing the specific locations to stored general locations; and
determining an installation location of the deck in the workspace relative to a factory installation.

21. The method of claim 16, further comprising:
moving the liquid dispenser to determine a first coordinate;
moving a carriage of the transport device to which the liquid dispenser is mounted to determine a second coordinate; and
moving a bridge of the transport device to which the carriage is mounted to determine a third coordinate.

22. A method of framing a workspace for a robotic fluid handler, the method comprising:
using a transportation device to position a framing tool within the workspace of the robotic fluid handler;
moving the framing tool to an expected starting location for a feature of the workspace that is pre-programmed into a controller of the robotic fluid handler;
moving the framing tool into contact with the feature;
sensing contact with the feature via an impedance-based sensor of the controller that is in electrical communication with the framing tool;
calculating an actual location for the feature; and
storing the actual location in the controller.

23. The method of claim 22, where moving the framing tool into contact with the feature comprises executing a series of movements of the framing tool to contact multiple surfaces of the feature to define a location of the feature in three-dimensional space relative to the transportation device.

24. The method of claim 22, wherein the feature of the workspace is a feature of a labware holder that is attached to a deck of the workspace.

25. The method of claim 24, further comprising:
attaching a pipette tip onto the framing tool, such that the pipette tip is electrically coupled to the impedance-based sensor;
loading a piece of labware onto the labware holder that is attached to the deck of the workspace;
contacting the pipette tip to a feature of the piece of labware;
sensing the contact of the pipette tip to the feature of the piece of labware via the impedance-based sensor;
calculating an actual location for the feature of the piece of labware based on the sensed contact; and
verifying proper seating of the piece of labware in the robotic fluid handling system based on the calculated actual location for the feature of the piece of labware.

26. The method of claim 24, further comprising mapping a three-dimensional geometry of the labware holder in the workspace based on the actual location.

27. The method of claim 26, further comprising mapping a three-dimensional geometry of a piece of labware loaded into the labware holder.

28. A robotic fluid handling system comprising:
a controller;
a stationary deck;
a component attached to the deck;
a transport device controlled by the controller to move in three-dimensional space; and
a liquid dispenser configured to dispense liquid into a piece of labware attached to the deck, the liquid dispenser arranged and adapted to be moved in three-dimensional space by the transport device, the liquid dispenser comprising an impedance-based sensor,
wherein the controller is configured to detect contact of the liquid dispenser with a plurality of features of the component of the deck based on the amount of impedance sensed by the impedance-based sensor,
wherein the controller is further configured to determine a location of the component in three-dimensional space based on the detected contact with the plurality of features.

29. The robotic fluid handling system of claim 28, wherein the plurality of features includes an inherent feature of the component.

30. The robotic fluid handling system of claim 28, wherein the component is a labware receptacle.

31. The robotic fluid handling system of claim 30, wherein the controller is further configured to determine a location, in three-dimensional space, of a piece of labware reversibly placed in the labware receptacle based on a detected contact of the liquid dispenser with a plurality of features of the piece of labware.

32. The robotic fluid handling system of claim 28, wherein the liquid dispenser comprises a pipette tip electrically coupled to the impedance-based sensor, wherein the controller is further configured to determine a location of an end of the pipette tip in three-dimensional space based on a detected contact of the pipette tip with a fixed target on the deck.
